(19) United States
(12) Patent Application Publication
(10) Pub. No.: US 2012/0003122 A1
(43) Pub. Date: Jan. 5, 2012

(54) FLOW CONTROLLER ASSEMBLY FOR MICROFLUIDIC APPLICATIONS AND SYSTEM FOR PERFORMING A PLURALITY OF EXPERIMENTS IN PARALLEL

(75) Inventors: Emilio René Bodenstaff, Amsterdam (NL); Roelandus Hendrikus Wilhelmus Moonen, Amsterdam (NL)

(73) Assignee: AVANTIUM HOLDING B.V., Amsterdam (NL)

(21) Appl. No.: 13/255,154

(22) PCT Filed: Mar. 16, 2010
(86) PCT No.: PCT/NL2010/000044

§ 371 Date: Sep. 7, 2011

(30) Foreign Application Priority Data
Mar. 20, 2009 (NL) 2002647

(51) Int. Cl. G01N 31/00; F15D 1/00

(52) U.S. Cl. 422/67; 137/334

(57) ABSTRACT

A flow controller assembly for microfluidic applications includes at least one microfluidic flow controller, which includes a microfluidic chip, a thermal energy transmitter, a flow sensor for measuring the flow rate of a fluid running through the flow controller and a data control unit. The data control unit, which is connected to the flow sensor by a first data connection which allows the data control unit to receive flow rate measurement data from the flow sensor, and which is also connected to the thermal energy transmitter by a second data connection allows the data control unit to influence the thermal output of the thermal energy transmitter, includes a data processing unit that determines the difference between the measured flow rate and a preset desired flow rate and to regulate the thermal output of the thermal energy transmitter in order to obtain or maintain the desired flow rate.

### CROSS-REFERENCE TO RELATED APPLICATIONS

This application is the National Stage of International Application No. PCT/NL2010/000044, filed Mar. 16, 2010, which claims the benefit of Netherlands Application No. 2002647, filed Mar. 20, 2009, the contents of which is incorporated by reference herein.

### FIELD OF THE INVENTION

The invention relates to a microfluidic flow controller assembly and to a system for performing a plurality of experiments in parallel, in particular for performing a plurality of microfluidic experiments in parallel.

### BACKGROUND OF THE INVENTION

When multiple chemical experiments are to be carried out, it is currently common practice to carry out these experiments in parallel in order to save time. Furthermore, for reasons of efficiency, safety, cost reduction and space reduction, such experiments are carried out on a small scale, in small reactors with small quantities of reagents. This miniaturisation of experiments leads to specific requirements for the equipment that is being used in such miniature experiments.

In those miniaturised experiments, often referred to in the art as “microfluidic experiments”, the flow rate of fluid reagents per reactor is very low, for example when the fluid is a liquid less than 1 millilitre per minute, often even less than 1 microliter per minute. When the fluid is a gas, for example a gas flow rate of less then 100 Nml/min, and often of less than 50 Nml/minute occurs. The control of such small flow requires dedicated equipment.

When those miniaturised experiments are performed in parallel, the flow of fluid reagent often has to be distributed evenly over the plurality of reactors, or in a predetermined ratio of flow rates. As conventional flow controllers are generally bulky and expensive, for example in WO99/64160 it has been proposed to use passive flow controllers such as capillaries for flow control. However, capillaries have proven hard to calibrate, as their resistance to fluid flow is very sensitive to the inner diameter and the length of the capillary. Due to manufacturing tolerances, obtaining a capillary with the just the desired flow resistance has proven to be a cumbersome process. Also, capillaries are fragile equipment, so they are hard to handle for lab personnel.

WO99/64160 in addition discloses a method for controlling the flow rate in a capillary tube, thereby making it an active flow controller instead of a passive flow controller. In this method, the flow rate of the fluid through the capillary is changed by heating the capillary. This causes the viscosity of the fluid to decrease, so that the capillary's resistance to fluid flow is reduced and the flow rate through the capillary increases. A mass flow sensor measures the flow rate downstream of the heater. The measurement data of the mass flow sensor is used in a feed back loop of the control system.

This method may overcome some calibration problems that the capillary tubes have, but the problems of the fragility of the capillaries remain. Also, it is hard to install the heater and the sensor on the capillary tubes. This is a serious disadvantage, as usually for every new experiment, new capillaries have to be prepared due to differences in the desired flow regime of different experiments or due to differences in viscosity of the fluid reagents in different experiments.

### SUMMARY OF THE INVENTION

The object of the invention is to provide an improved flow controller assembly for microfluidic applications, and an improved system for performing a plurality of experiments in parallel.

This object is achieved with a flow controller assembly according to the present invention and/or with the systems for performing parallel experiments according to the present invention.

In the flow controller assembly according to the invention and in the systems in which the same general idea is used, a microfluidic chip is provided that has a channel therethrough. The channel in the microfluidic chip has a similar function as the capillary in known systems: to provide a predetermined resistance to fluid flow, that is preferably relatively high when compared to the flow resistance in other parts of the experimental platform.

The microfluidic chip can be made from glass (such as borosilicate glass), quartz, computer chip-like silica, metal or the like. It is easier to handle than a capillary tube, which is in general long and thin, and springy. The microfluidic chip is also significantly sturdier than a capillary tube. Microfluidic chips are commercially available from for example Micronit, NSG Precision Cells Inc., and MicroLIQUID. Microfluidic chips are for example used for diagnostic tests, capillary electrophoresis, DNA-sequencing or cell counting. Often, those microfluidic chips come together with a chip holder that makes it easy to connect fluid feed lines and fluid discharge lines to the microfluidic chip. This helps to achieve a quick and easy set-up of the flow controller and of the parallel experiments system.

The flow controller assembly according to the invention further comprises a thermal energy transmitter. This can be a heater, a cooler or a device that can heat as well as cool. The thermal energy transmitter is adapted for heating and/or cooling at least a part of the channel in the microfluidic chip. By doing so, any fluid flowing through that part of the channel is heated and/or cooled as well, so that its viscosity changes. As the viscosity of the fluid is one of the parameters determining the resistance to fluid flow of a channel, the flow rate of fluid flow through that channel is influenced as well. In general, if the channel is heated, the viscosity of the fluid will decrease, and the flow rate will increase. When the channel is cooled, it is the other way around. This principle is used to actively control the flow rate through the channel in the flow controller assembly according to the invention.

In an active flow controller such as the one according to the invention, the actual flow rate is measured and compared to a preset value of the desired flow rate. If the difference between the measured flow rate and the desired flow rate exceeds a certain threshold, action is taken to reduce this difference. The value of the threshold depends on the specific application; in some applications it may be zero, so there is no real threshold in flow controller assembly set up. In other applications, the threshold may be for example 5% of the desired flow rate. In that case, a measured flow rate that is within a bandwidth of +5% to −5% around the optimal value of the desired flow rate does not give rise to a change in thermal output of the thermal energy transmitter. So, the preset desired flow rate can be either a value or a range.

The thermal energy transmitter can be designed as a tracing wire that is arranged adjacent to the channel or a adjacent to a part of the channel. The tracing wire can be attached to the outside of the microfluidic chip, or it can be embedded therein. It is common for microfluidic chips to be composed of two layers of substrate. In one layer, the channel is made, for example by (micro)machining or by etching. The channel is over its length open on one side. A second layer of substrate covers the first layer, and closes the channel over its length. Of course, an inlet and an outlet of the channel remain open. A tracing wire can be arranged between the first and second substrate layer. Instead of a tracing wire, metal tracing that is deposited on one or both of the layers can be used. It is also possible to use metal deposits on the outside of the microfluidic chip.

Alternatively or in addition, the microfluidic chip can be heated or cooled by arranging it in or adjacent to a thermal fluid, that either flows or is stationary. It is also possible that the microfluidic chip comprises a second channel for the thermal fluid to pass through.

Alternatively or in addition, cooling can be achieved by means of a Peltier element.

For measuring the actual flow rate, a flow sensor is provided in the flow controller assembly according to the invention. In practice, a flow sensor using the time-of flight principle has turned out to be a suitable choice. In such a sensor, at a first location in the channel, a marker is given to the fluid. At a second location, downstream of the first location, the passing by of the marker is detected. The time that lapsed between applying the marker at the first location and detecting the marker at the second location is recorded. As the first location and the second location are at a known distance from each other, the flow rate can be calculated from the recorded time lapse.

In a particularly advantageous embodiment, the time-of-flight flow sensor uses a thermal pulse as a marker. In such an embodiment, a thermal pulse element is arranged adjacent to the channel at a first location. This thermal pulse element can for example be a wire having an electrical resistance that is attached to the microfluidic chip, or it can comprise metal deposits on or in the microfluidic chip. By connecting the wire or metal deposits to a power source, a thermal pulse can be generated. This embodiment of the thermal pulse element is suitable to be integrated into the design of the microfluidic chip. The thermal pulse is detected by a thermal pulse sensor, that is arranged at a second location adjacent to the channel in the microfluidic chip, downstream at a known distance from the thermal pulse element.

In an advantageous embodiment, a housing is provided that can accommodate the microfluidic chip, and possibly also other elements of the flow controller assembly. Preferably this housing is gas tight, so that if a reagent—for example in the form of a gas or liquid—somehow escapes, for example due to leakage, the safety risk is reduced. Preferably, the housing is thermally insulated. This improves the accuracy and response time of the flow controller.

In a preferred embodiment, the housing is provided with an indicator that indicates whether a microfluidic chip is present or not.

In a preferred embodiment, the housing is provided with connectors for connecting fluid feed lines and/or fluid discharge lines.

The flow controller assembly can comprise a plurality of microfluidic flow controllers.

In a system for performing a plurality of experiments (or chemical reactions in general) in parallel, a flow controller assembly according to the invention is provided. This flow controller assembly is connected to at least one source of fluid reagent. The system further comprises a plurality of reactors, that are connected to the source of fluid reagent via the flow controller assembly.

In a possible embodiment, a plurality of flow controller assemblies according to the invention are provided, each flow controller assembly comprising a single microfluidic flow controller. In this embodiment, all flow controller assemblies are connected to the source of fluid reagent. Each of the flow controller assemblies is connected to a single reactor.

In a different possible embodiment, a single of flow controller assembly according to the invention is provided, the flow controller assembly comprising a single microfluidic flow controller. In this embodiment, all flow controller assembly is connected to the source of fluid reagent. The flow controller assembly is connected to a plurality of reactors.

In a further possible embodiment, a single of flow controller assembly according to the invention is provided, the flow controller assembly comprising a plurality of microfluidic flow controllers. In this embodiment, the flow controller assembly is connected to the source of fluid reagent. Each of the microfluidic flow controllers is connected to a single reactor.

In a further possible embodiment, a plurality of flow controller assemblies according to the invention are provided, the flow controller assemblies comprising a plurality of microfluidic flow controllers. In this embodiment, the flow controller assemblies are connected to the source of fluid reagent. Each of the microfluidic flow controllers is connected to a single reactor.

Combinations of the above embodiments are possible too. It is possible that any of these embodiments comprise a plurality of sources of fluid reagents.

The system may comprise a system control unit that is connected to the data control units of the individual microfluidic flow controllers of the system.

It is envisaged that the preset desired flow rate is the same for all microfluidic flow controllers in the system. It is also envisaged that the desired flow rates are distributed in accordance with a predetermined ratio over the microfluidic flow controllers of the system, for example 1:2:3:4: . . .

In a system for performing a plurality of experiments (or chemical reactions in general) in parallel that comprises multiple microfluidic flow controllers and/or flow controller assemblies according to the invention, it is possible that some elements are shared. For example, it is possible to have a thermal energy transmitter that acts on a plurality of channels in the system. It is also possible that a system data control unit is present, that receives flow rate measurement data from a plurality of flow sensors, and/or regulates the thermal output of a plurality of thermal energy transmitters. It is also possible that multiple microfluidic chips are arranged in a single housing.

### BRIEF DESCRIPTION OF THE DRAWINGS

The invention will be explained in more detail under referral to the drawing, in which non-limiting embodiments of the invention are shown. The drawings show in:

FIG. 1: an example of a commercially available microfluidic chip,

FIG. 2: a first embodiment of a microfluidic flow controller according to the invention,

FIG. 3: an embodiment in which a flow controller assembly according to FIG. 2 is provided with a housing,

FIG. 4: a second embodiment of the flow controller assembly according to the invention,

FIG. 5: a variant of the embodiment of FIG. 4,

FIG. 6: a flow controller assembly according to the invention applied in a reaction system,

FIG. 7: a reaction system for performing a plurality of parallel experiments in which a flow controller assembly according to the invention is used,

FIG. 8: a second embodiment of a reaction system for performing a plurality of parallel experiments in which flow controller assemblies according to the invention are used,

FIG. 9: a third embodiment of a reaction system according to the invention,

FIG. 10: a further possible embodiment of arranging a microfluidic chip as used in the invention in a housing, and

FIG. 11: a further embodiment of a housing for microfluidic chips that can be used in a flow controller assembly according to the invention.

### DETAILED DESCRIPTION OF THE INVENTION

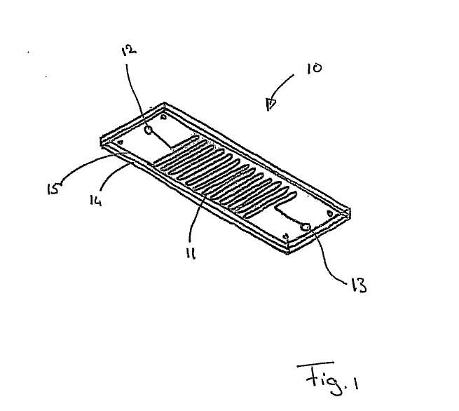

FIG. 1 shows an example of a commercially available microfluidic chip 10. This chip 10 comprises a channel 11, having a channel inlet 12 and a channel outlet 13. The chip 10 comprises a first substrate layer 14 and a second substrate layer 15.

In this example, the microfluidic chip 10 is made from borosilicate glass. It is however also possible that microfluidic chips used in the invention are made from other materials, such as different types of glass, quartz, silica (for example the material used for electronic chips or a material similar to that) or metal.

In the example of FIG. 1, the channel 11 is etched or (micro)machined in the first substrate layer 14. The channel 11 is open over its length, as this is the most convenient way of making the channel 11 in the first substrate layer 14. The channel 11 is then closed over its length by arranging the second substrate layer 15 on top of the first substrate layer 14. The substrate layers 14, 15 are then bonded to each other, in such a way that no fluid can escape from the channel 11 into the interface between the first substrate layer 14 and the second substrate layer 15. The bonding of the substrate layers 14,15 with each other can for example be achieved by gluing, welding or the like. The optimal choice for the bonding process will depend for example on the material of the substrate layers and the pressure requirements on the microfluidic chip.

The channel inlet 12 and the channel outlet 13 are in the example of FIG. 1 arranged at the top of the chip 10. However, they can also be arranged at one or more of the four side faces and/or at the bottom of the chip 10.

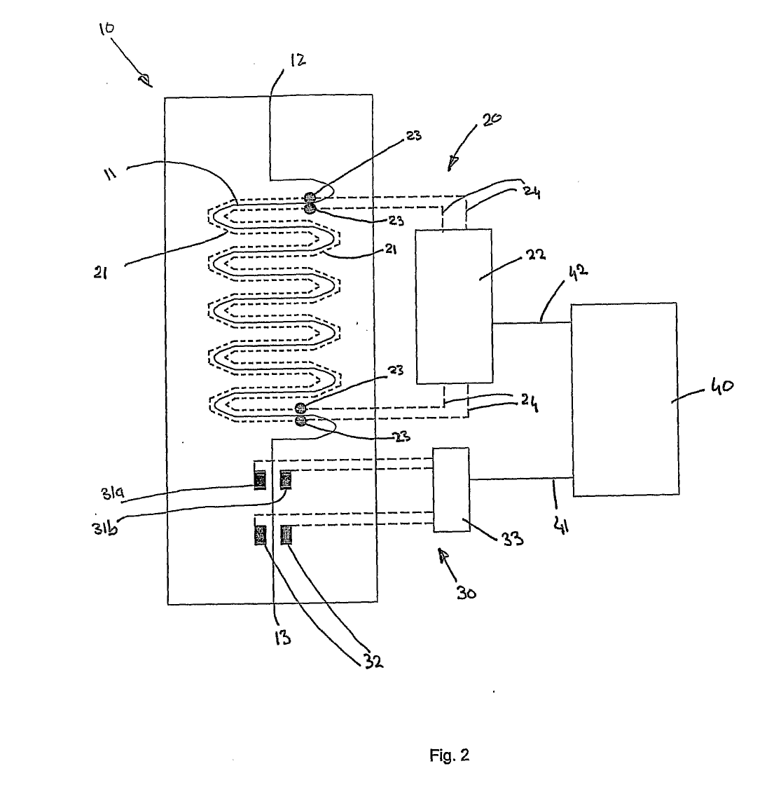

FIG. 2 shows a first embodiment of a microfluidic flow controller according to the invention.

FIG. 2 shows a microfluidic chip 10 that comprises a channel 11 for accommodating a fluid flow. The fluid can be a gas, a liquid, a combination of gas and liquid, a gel or the like.

The channel 11 has a channel inlet 12, which can be connected to a fluid source, for example a volume of gas or liquid under pressure. The channel also has a channel outlet 13, which can be connected to a further fluid conduit, which takes the fluid to a point where it is used (like a reactor) or to waste.

The microfluidic flow controller according to the invention comprises a thermal energy transmitter 20. Physically, the chip 10 is provided with tracing wires 21, that in this example run alongside a part of the channel 11 on two sides thereof. The tracing wires 21 have an electrical resistance, which causes them to heat up when an electric current runs through them. The tracing wires 21 are preferably embedded in the microfluidic chip 10, between the substrate layers 14,15. They can be actual wires that are for example glued to at least one of the substrate layers 14,15, but they can also be made of metal deposits on one of the substrate layers 14,15, for example by means of chemical vapour deposition.

The tracing wires can as an alternative or in addition be arranged on the outside surface of the microfluidic chip 10 as well.

In the example of FIG. 2, the tracing wires 21 run alongside the channel 11. However, they can be laid out in different patters as well, for example in a grid.

The tracing wires 21 are provided with connection points 23. At these points 23, connection wires 24 can be attached. The connection wires 24 connect the tracing wires 21 with a thermal controller 22. The thermal controller 22 controls the thermal energy transmitter 20.

As an alternative or in addition, the thermal energy transmitter 20 can be provided with a Peltier element, so that cooling of the channel 11 can be achieved too.

It is possible that a thermal sensor is provided (not shown in FIG. 2) that measures the temperature of the fluid flowing through the channel 11 or for example of the surface of the microfluidic chip in the vicinity of the channel 11.

The microfluidic flow controller further comprises a flow sensor 30. In this example, the flow sensor 30 uses the time-of-flight principle to measure the flow rate of the fluid flow through the channel 11.

To that end, the flow sensor 30 has been provided with a thermal pulse element 31. This thermal pulse element 31 is arranged adjacent to the channel 11. In this example, the thermal pulse element has two thermally active parts 31a,b, that are arranged on either side of the channel 11. However, it is also possible that the thermal pulse element is arranged on one side of the channel 11, or that it at least partly extends around the channel 11.

The thermal pulse element 31 is designed to generate a thermal pulse, for example a heat pulse in the fluid in the channel 11.

Downstream of the thermal pulse element 31, at some distance of the thermal pulse element 31, a thermal sensor 32 is arranged. This thermal sensor 32 detects the passing by of the thermal pulse that was generated by the thermal pulse element 31. As the distance between the thermal pulse element 31 and the thermal sensor 32 is known, the time it takes for the thermal pulse in the fluid in the channel to reach the thermal sensor 32 is an indication of the flow rate of the fluid in the channel 11.

The flow sensor 30 is controlled by a sensor control unit 33. This sensor control unit is provided with a timer, that determines the time lapsed between the generation of the heat pulse by the thermal pulse element 31 and the detection of that heat pulse by the thermal pulse detector 32. This time lapse is called the “time of flight”.

The subsequent thermal pulses that are generated by the thermal pulse element can be all of the same intensity and length, but it is also possible that the thermal pulses vary in intensity and/or length. This is in particular useful when the time between two subsequent pulses is shorter than the time it takes for a pulse to reach the thermal pulse detector. By recognising the intensity and/or length of each pulse, the flow sensor control unit can then calculate the right time of flight that belongs to each individual pulse.

In this example, the flow sensor 30 is arranged downstream of the part of the thermal energy transmitter that is arranged adjacent the channel 11. However, the flow sensor 30 can also be arranged upstream thereof. It is also possible that multiple flow sensors 30 are present, upstream and/or downstream of the part of the thermal energy transmitter that is arranged adjacent the channel 11. In an advanced embodiment, one flow sensor is arranged upstream of the part of the thermal energy transmitter that is arranged adjacent the channel 11, and one is arranged downstream thereof. In that embodiment, the influence of the thermal energy transmitter 20 on the flow rate through the channel 11 can be monitored.

It is possible that other types of flow sensors are applied instead of or in addition to the flow sensor that works on the time-of-flight principle.

The microfluidic flow controller also comprises a data control unit 40 that controls the microfluidic flow controller. The data control unit 40 is connected to the flow sensor 30 by means of a first data connection 41. This first data connection 41 allows the data control unit to receive flow measurement data from the flow sensor 30.

The data control unit further comprises a second data connection 42. This second data connection 42 connects the data control unit 40 with the thermal energy transmitter 20. The data control unit 40 is adapted to control the thermal output of the thermal energy transmitter 20.

The controller 22 for the thermal energy transmitter 20 and/or the flow sensor control unit 33 can be integrated in the data control unit 40, or can be separate therefrom.

It is furthermore possible that the flow sensor assembly further comprises a second thermal sensor (not shown) that is used to monitor the temperature of the fluid passing through the channel 11. The data from this sensor is used in order to make sure that no undesired temperature levels in the fluid in the channel occur when the thermal energy transmitter heats or cools the fluid in the channel 11. For example, if the fluid is known to degrade above a certain temperature, this second sensor can provide data to the data control unit, that in turn prevents the thermal energy transmitter from heating up the fluid in the channel to a temperature above this degradation temperature. This feature also helps to prevent undesirable heating or cooling due to a system error, for example when the desired flow rate is set to a value that cannot be reached by the system (extremely low or high, for example, or when due to a system failure not enough fluid is supplied to the microfluidic chip.

The microfluidic flow controller according to the invention operates as follows.

A desired flow rate is set in the data control unit. This desired flow rate can be a value for the flow rate (for example: 0.1 ml per minute), or a flow rate range (for example “between 0.05 and 0.15 ml per minute”, or “0.1 ml per minute +/−10%”).

Fluid enters the microfluidic flow controller via the channel inlet 12 and passes through channel 11 in the microfluidic chip 10. Flow sensor 30 measures the flow rate of the fluid in the channel 11. The flow measurement data obtained by the flow sensor 30 is transferred to the data control unit 40 through the first data connection 41.

In the data control unit 40, the measured flow rate is compared to the preset desired flow rate. If the measured flow rate is different from the preset value of the desired flow rate or outside the preset flow rate range, action is taken to adapt the flow rate.

This adaptation of the flow rate is achieved by activating the thermal energy transmitter 20. If the measured flow rate is below the desired flow rate or below the minimum desired flow rate, the thermal energy transmitter provides the flow channel with additional heat. This way, the viscosity of the fluid in the channel of the microfluidic chip decreases and the flow rate of the fluid in the channel increases. Instead or in addition to the change in viscosity, other effects could also play a role in the change of the flow rate, such as the thermal expansion of the fluid and/or the channel.

If the measured flow rate is above the desired flow rate or above the maximum desired flow rate, the thermal energy transmitter provides the flow channel with less heat or even actively cools the channel. This way, the viscosity of the fluid in the channel of the microfluidic chip increases and the flow rate of the fluid in the channel decreases. Instead or in addition to the change in viscosity, other effects could also play a role in the change of the flow rate, such as the thermal expansion of the fluid and/or the channel. The thermal energy transmitter can supply less heat by reducing the thermal output. Cooling can for example be achieved by means of a Peltier element.

In a possible embodiment, the adaptation of the flow rate is done in iterating steps. The thermal output is changed for example such that the tracing wires are heated up by 1 degree Celsius, then the effect on the flow rate is determined. If the flow rate has not increased enough, then the tracing wires 21 are heated up by another 1 degree Celsius, and the flow rate is measured again. This is repeated until the desired flow rate is obtained, or until the flow rate is within the desired range.

If the flow rate is at the desired value or within the desired range, the thermal output of the thermal energy transmitter is adapted such that the temperature of the fluid does not change too much.

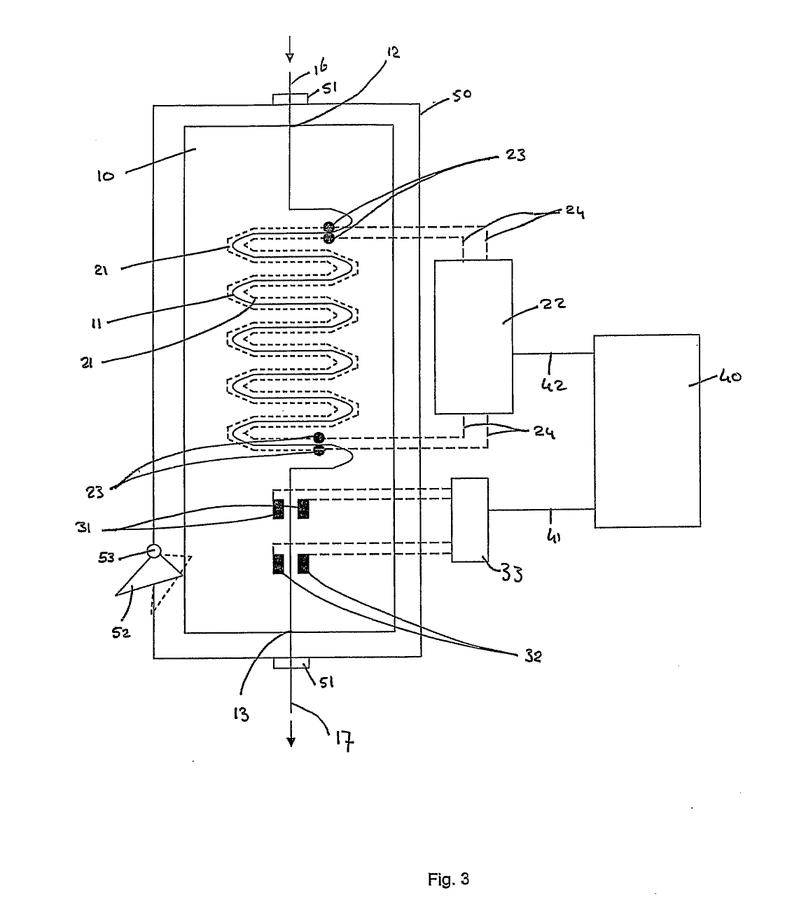

FIG. 3 shows an embodiment in which a flow controller assembly according to FIG. 2 is provided with a housing 50.

In the example of FIG. 3, the thermal controller 22, the sensor control unit 33 and the data control unit are arranged outside the housing 50. It is however also possible that one or more of these components are arranged inside the housing 50.

The housing 50 is provided with thermal insulation. This reduces the heat loss of the assembly. This makes the control of the flow rate more accurate and effective. When good thermal insulation is provided, the thermal output of the thermal energy transmitter is used effectively to heat or cool the fluid in the channel, as losses to the environment are reduced. This also makes that the response time of the flow controller assembly is reduced: the desired flow rate is obtained quicker.

In the embodiment of FIG. 3, the housing 50 is provided with connectors 51, that allow easy connection of a fluid supply line 16 to the inlet 12 of the microfluidic chip 10 and of a fluid discharge line 17 to the outlet 13 of the microfluidic chip 10.

Advantageously, the housing 50 is gastight and/or liquidtight. In that case, in the event of leakage of the microfluidic chip 10 and/or the connection between the microfluidic chip 10 and the fluid supply line 16 and/or the connection between the microfluidic chip 10 and the fluid discharge line 17, no gas or liquid escapes from the housing.

In the embodiment of FIG. 3, an indicator 52 is provided. The indicator 52 indicates whether a microfluidic chip 10 is present in the housing 50 or not. In this example, the indicator is mounted such that it can pivot around axis 53. Indicator 52 is spring biased, such that when no microfluidic chip 10 is present in the housing, the tip of the indicator is close to the outside face of the housing 50. This position of the indicator 52 is shown in dashed lines in FIG. 3. When a microfluidic chip 10 is inserted in the housing 50, it pushes indicator 52 outward. This position in shown in FIG. 3 in solid lines.

This is of course only one example of how an indicator can be realised that shows whether a microfluidic chip 10 is present in housing 50 or not. It is for example also possible to provide the housing 50 with a window through which it can be visually checked whether a microfluidic chip 10 is present or not. An other option is for example that by arranging a microfluidic chip 10 in the housing 50, a switch is operated that for example closes an electric circuit such that a light (for example a LED) in switched on.

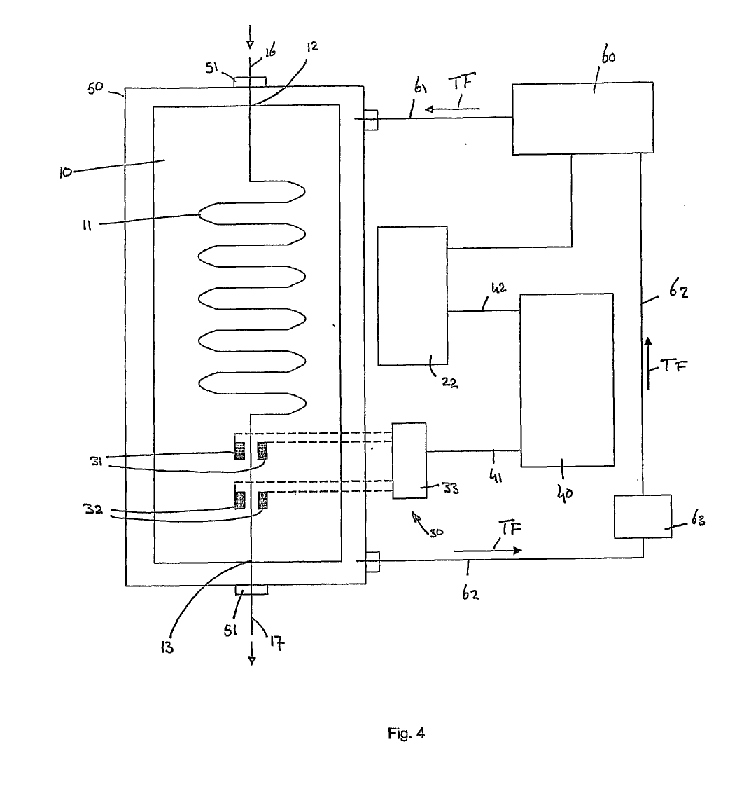

FIG. 4 shows a second embodiment of the flow controller assembly according to the invention.

In the embodiment of FIG. 4, just like in the previously described embodiments, a microfluidic chip 10 is arranged in housing 50. Microfluidic chip 10 again comprises an inlet 12, an outlet 13 and a channel that extends from inlet 12 to outlet 13. The housing is provided with connectors 51, that allow coupling of a fluid supply line 16 to the inlet 12 of the microfluidic chip 10 and coupling of a fluid discharge line 17 to the outlet 13 of the microfluidic chip 10. Also, a time-of-flight type flow sensor 30 in provided, like in the previously described embodiment. However, in the embodiment of FIG. 4, a different kind of thermal energy transmitter is used.

In the embodiment of FIG. 4, a reservoir 60 for thermal fluid is provided. This reservoir 60 is in fluid communication with the inside of the housing 50 by means of a thermal fluid supply line 61 and a thermal fluid discharge line 62. The temperature of thermal fluid in the thermal fluid reservoir 60 is controlled by thermal controller 22. A thermal fluid pump 63 is provided, and arranged such that a thermal fluid can be circulated through a circuit comprising the reservoir 60, the thermal fluid supply line 61, the inside of the housing 50 and the thermal fluid discharge line 62, as indicated by the arrows TF.

In operation, the thermal fluid reservoir 60 is at least partly filled with a thermal fluid, which is a fluid that is capable of transferring heat to an object or to which heat can be transferred from an object. In the reservoir 60, the thermal fluid is heated or cooled to a desired temperature. To that end, the thermal fluid reservoir 60 is provided with a heater and/or cooler. Thermal controller 22 controls the temperature in the reservoir 60.

The thermal controller 22 makes the heater or cooler of the thermal fluid reservoir 60 bring the temperature of the thermal liquid to the desired temperature. The pump 63 makes the thermal fluid circulate through the circuit comprising the reservoir 60, the thermal fluid supply line 61, the inside of the housing 50 and the thermal fluid discharge line 62. This way, the thermal fluid also flows over the microfluidic chip, thereby heating or cooling the microfluidic chip 10 and therewith the fluid in the channel 11 of the microfluidic chip as well.

The viscosity of the fluid in the channel of the microfluidic chip changes with the change in temperature and therewith the flow rate of the fluid in the channel changes as well. Instead or in addition to the change in viscosity, other effects could also play a role in the change of the flow rate, such as the thermal expansion of the fluid and/or the channel.

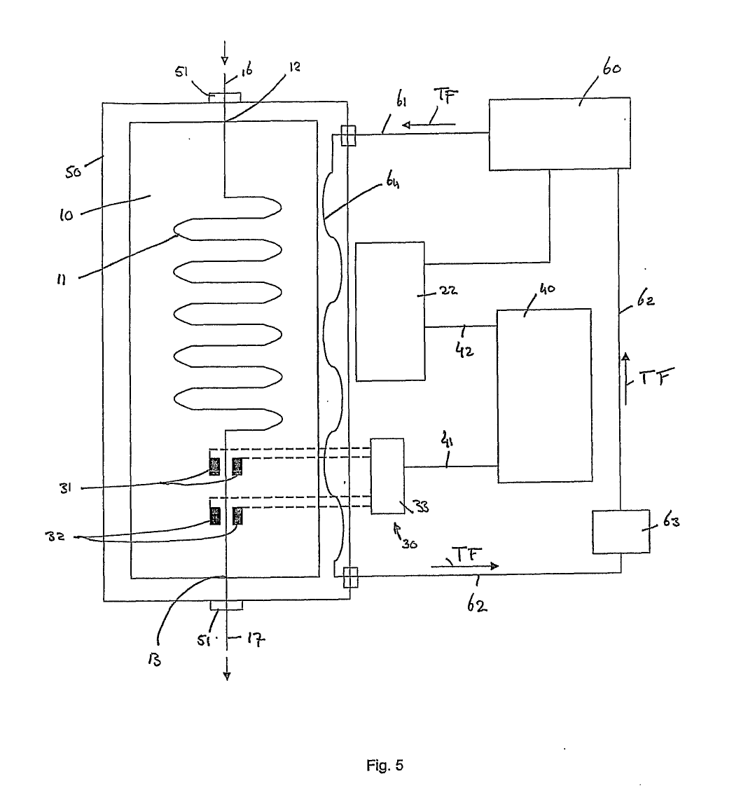

FIG. 5 shows a variant of the embodiment of FIG. 4. In this variant, the thermal fluid does not flow freely through the housing 50, but it flows through passage 64. This passage 64 is arranged inside the housing 50, in such a way that the thermal fluid flowing through the passage 64 can heat or cool any fluid that is present in the channel 11 of the microfluidic chip 10, for example by means of heating and/or cooling the microfluidic chip 10.

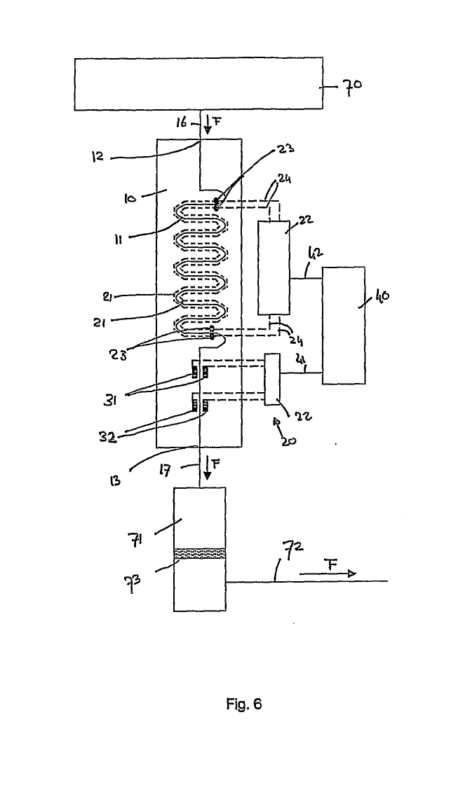

FIG. 6 shows a flow controller assembly according to the invention applied in a reaction system. In the example of FIG. 6, a flow controller assembly according to FIG. 2 is used, but it will be clear to the skilled person that other embodiments of the flow controller assembly according to the invention can be used as well.

In the reaction system according to FIG. 6, a source 70 of fluid reagent is provided. This source is in fluid connection with channel 11 of the flow controller assembly by means of fluid supply line 16. Fluid discharge line 17 is connected to the outlet 13 of the flow controller assembly, and to a reaction vessel 71, which is in this example provided with fixed bed 73. However, the reaction vessel 71 can be of any type suitable for the reaction to be performed. So, fluid discharge line 17 provides fluid communication between the flow controller assembly and the reaction vessel 71. The fluid flow or reagent and reaction products is indicated by the arrows F.

Reaction products are removed from the reaction vessel 71 through reaction product discharge line 72. This line can take the reaction products to for example an online analyser, a collection point for offline analysis, waste or a selection valve.

In the system of FIG. 6, the flow controller assembly is used to control the flow rate of the reagent from the source 70 to the reaction vessel 71.

In general, fluid reagent source 70 will be pressurised in order to obtain a flow of the fluid reagent to the reaction vessel 71. However, it is also possible that other ways of creating a fluid flow are used, such as applying a voltage differential.

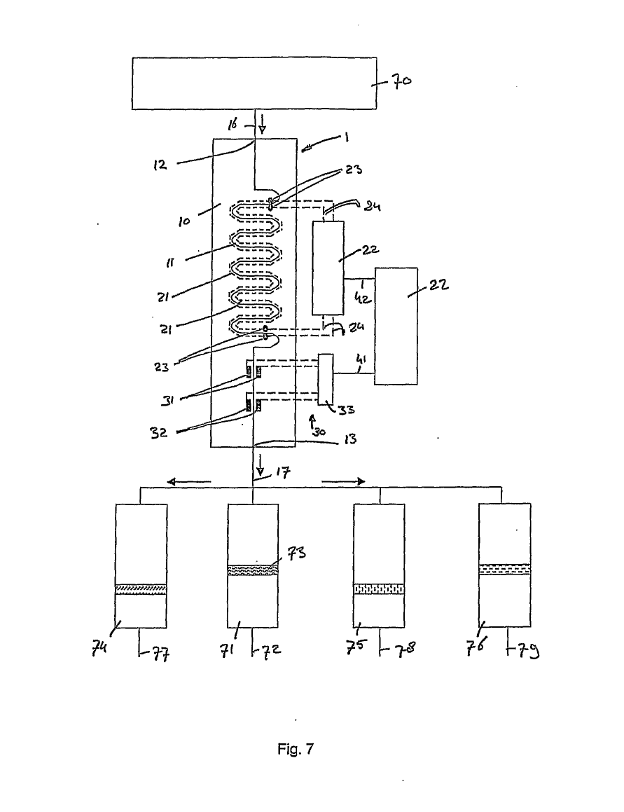

FIG. 7 shows a reaction system for performing a plurality of parallel experiments in which a flow controller assembly 1 according to the invention is used. In the example of FIG. 7 a flow controller assembly according to FIG. 2 is used, but it will be clear to the skilled person that other embodiments of the flow controller assembly according to the invention can be used as well.

In the system according to FIG. 7, a single source of fluid reagent 60 is present to feed reagent to the reaction vessels 71,74,75,76, which are arranged in parallel. A single flow controller assembly according to the invention is present to control the flow rate to the reaction vessels. Reagent product discharge lines 72,77,78,79 discharge the reaction products from the respective reaction vessels 71,74,75,76.

The flow controller assembly operates as described above, and controls the flow rate of the fluid reagent from the source 70 to the parallel reactors. If the resistance to fluid flow downstream of the flow controller is the same for all reaction vessel, the flow rate through all reaction vessels will be at least substantially equal.

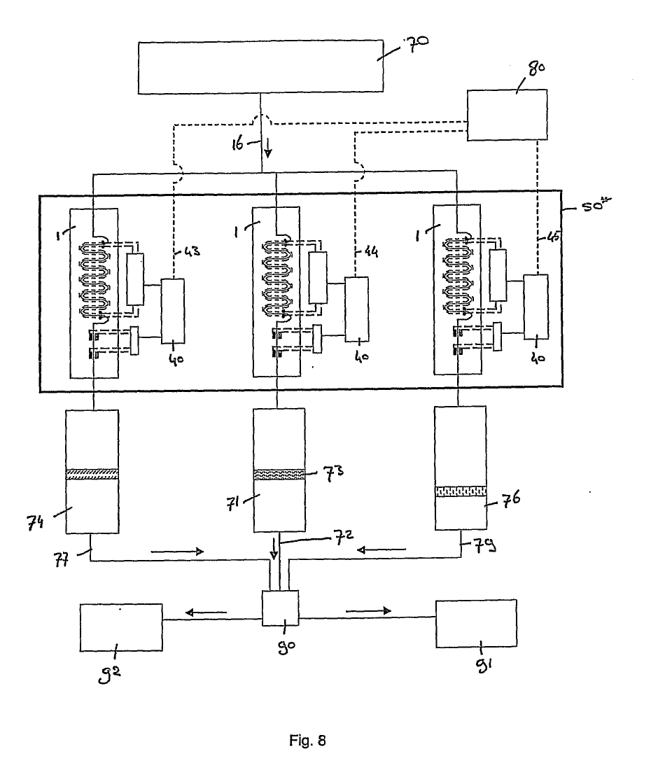

FIG. 8 shows a second embodiment of a reaction system for performing a plurality of parallel experiments in which flow controller assemblies according to the invention are used.

In this embodiment, each reaction vessel has its own associated flow controller assembly 1. In the example of FIG. 8, flow controller assemblies according to FIG. 2 are used, but it will be clear to the skilled person that other embodiments of the flow controller assembly according to the invention can be used as well. It is not necessary that all flow controller assemblies are identical. It is for example possible that different microfluidic chips are used, with different lengths and/or diameters of the channels 11.

Fluid reagent (a gas, liquid, gel or the like) is supplied by a single fluid reagent source 70. From the fluid reagent source 70, the fluid reagent flows to one of the reaction vessels 71,74,76 via the flow controller assembly 1 that is associated with that reaction vessel 71,74,76. In the example of FIG. 8, the reaction vessels are fixed bed reactors, but any other type of reactor that is suitable for the experiment that is to take place is possible as well. For example, it is possible that reagents from different sources are fed into the reactors.

In the example of FIG. 8, the reaction product discharge lines 72,77,79 take the reaction products from the reaction vessels 71,74,76, respectively, to a selection valve 90. Depending on the setting of the selection valve 90, the reaction products from a reaction vessel go either to an online analyser 91 or to waste 92.

It will be clear to the skilled person that this configuration of selection valve 90, online analyser 91 and waste 92 can also be used in combination with other embodiments of the flow controller assembly and/or other embodiments of the reaction system according to the invention. Also, on the other hand, it is possible to direct the reaction products of one or more of the reaction vessels of the embodiment of FIG. 8 to waste and/or online analysis directly, or for example to a collection point for offline analysis.

In the embodiment of FIG. 8, the flow controller assemblies are arranged in a common housing 50*. Of course, it is also possible that each flow controller assembly is arranged in an individual housing, or that each flow controller assembly is arranged in an individual housing and that these individual housings are arranged together in a further, common housing.

In the embodiment of FIG. 8, the data control units 40 of each flow controller assembly are connected to a single system control unit 80 by means of data connections 43,44,45. The system control unit 80 coordinates the actions of the individual flow controller assemblies, for example in order to obtain a desired flow rate ratio of the individual fluid flows to the individual reaction vessels 71,74,76.

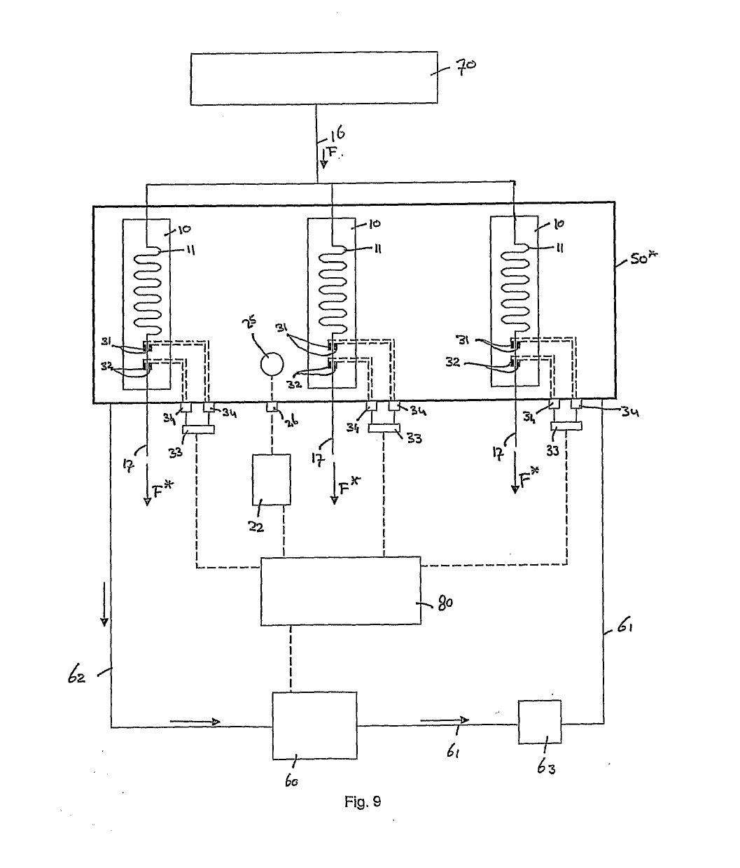

FIG. 9 shows a third embodiment of a reaction system according to the invention.

In the example of FIG. 9, the reaction system comprises a single source 70, supplying fluid reagent. It is also possible that multiple sources of reagent are present. It is possible that different sources supply different reagents to different reaction vessels or groups of reaction vessels. In addition or as an alternative, it is possible that a single reaction vessel received different reagents from different sources.

In FIG. 9, arrows F* indicate the fluid flow leaving the fluid discharge lines 17. The reaction vessels into which the fluid flows are discharged are not shown in FIG. 9, for the sake of clarity. From the reaction vessels, the reaction products are discharged to for example an online analyser, a collection point for offline analysis or to waste.

The system further comprises a plurality of microfluidic chips 10. Each microfluidic chip has a channel 11 for accommodating a fluid flow. Fluid supply line 16 provides fluid communication between the fluid reagent source 70 and the microfluidic chips 10.

The microfluidic chips 10 are arranged in a common housing 50*. It is also possible that each microfluidic chip 10 is arranged in its own housing, or that multiple housings are provided, each accommodating one or more microfluidic chips 10. In that case, it is not necessary that all housings contain the same number of microfluidic chips 10.

The system further comprises a thermal energy transmitter. In this example, a thermal energy transmitter according to FIG. 4 is used. In this embodiment, a thermal fluid is circulated through the thermal fluid reservoir 60, the thermal fluid supply line 61, the common housing 50*, the thermal fluid discharge line 62 and the thermal fluid pump 63.

Thermal sensor 25 measures the temperature in the common housing 50*. This data is supplied to the thermal control unit 22. Advantageously, the housing 50* is provided with a connector 26 that allows easy connection of the thermal sensor 25 to the thermal control unit 22. Thermal control unit 22 is connected to system control unit 80, such that that data provided by the thermal sensor 25 can be used in the overall control of the system.

Each of the microfluidic chips 10 is provided with a time-of-flight flow sensor of the type described in relation to FIG. 2 and used in other embodiments as well. This flow sensor is provided with a thermal pulse element 31. This thermal pulse element 31 is arranged adjacent to the channel 11. In this example, the thermal pulse element has two thermally active parts 31a,b, that are arranged on either side of the channel 11. However, it is also possible that the thermal pulse element is arranged on one side of the channel 11, or that it at least partly extends around the channel 11.

The thermal pulse element 31 is designed to generate a thermal pulse, for example a heat pulse in the fluid in the channel 11.

Downstream of the thermal pulse element 31, at some distance of the thermal pulse element 31, a thermal sensor 32 is arranged. This thermal sensor 32 detects the passing by of the thermal pulse that was generated by the thermal pulse element 31. As the distance between the thermal pulse element 31 and the thermal sensor 32 is known, the time it takes for the thermal pulse in the fluid in the channel to reach the thermal sensor 32 is an indication of the flow rate of the fluid in the channel 11.

The flow sensor 30 is controlled by a sensor control unit 33. This sensor control unit is provided with a timer, that determines the time lapsed between the generation of the heat pulse by the thermal pulse element 31 and the detection of that heat pulse by the thermal pulse detector 32. This time lapse is called the “time of flight”.

In this embodiment, the sensor control unit 33 is arranged outside the common housing 50*. Connectors 34 provide an easy connection between the thermal pulse elements 31 and the sensor control unit 33, and between the thermal pulse sensors 32 and the sensor control unit 33.

The sensor control unit 33 is connected to the system control unit 80 such that the data from the sensors can be used for the overall control of the system.

The system control unit 80 is also connected to the thermal fluid reservoir 60. Based on the data that the system control unit 80 receives from the thermal sensor 25 and from the flow sensors, the system control unit 80 controls the temperature of the thermal fluid in the reservoir 60, so the flow rate through the channels 11 in the microfluidic chips can be controlled.

To that end, the system data control unit comprises a system data processing unit that is adapted to determine the difference between the measured flow rate in each channel and a preset desired flow rate for that channel and to regulate the thermal output of the thermal energy transmitter in order to obtain or maintain the desired flow rates. In the example, the control of the output of the thermal energy transmitter is carried out by means of controlling the temperature of the thermal fluid in the thermal fluid reservoir 60.

Instead of the thermal energy transmitter according to FIG. 4, other thermal energy transmitters can be used. The thermal energy transmitter as shown in FIG. 4 and FIG. 9 is simple in design, but it does not allow individual flow control of the different microfluidic chips that are present in the common housing 50*. For example, as an alternative (or in addition) it is possible to provide each microfluidic chip with tracing wires 21 connected to the thermal controller 22, as is shown in FIG. 2. It is also possible the a thermal energy transmitter of the type shown in FIG. 5 is used, either with a single passage passing by multiple or all microfluidic chips 10 in the system, or with separate passages for each individual microfluidic chip 10 in the system.

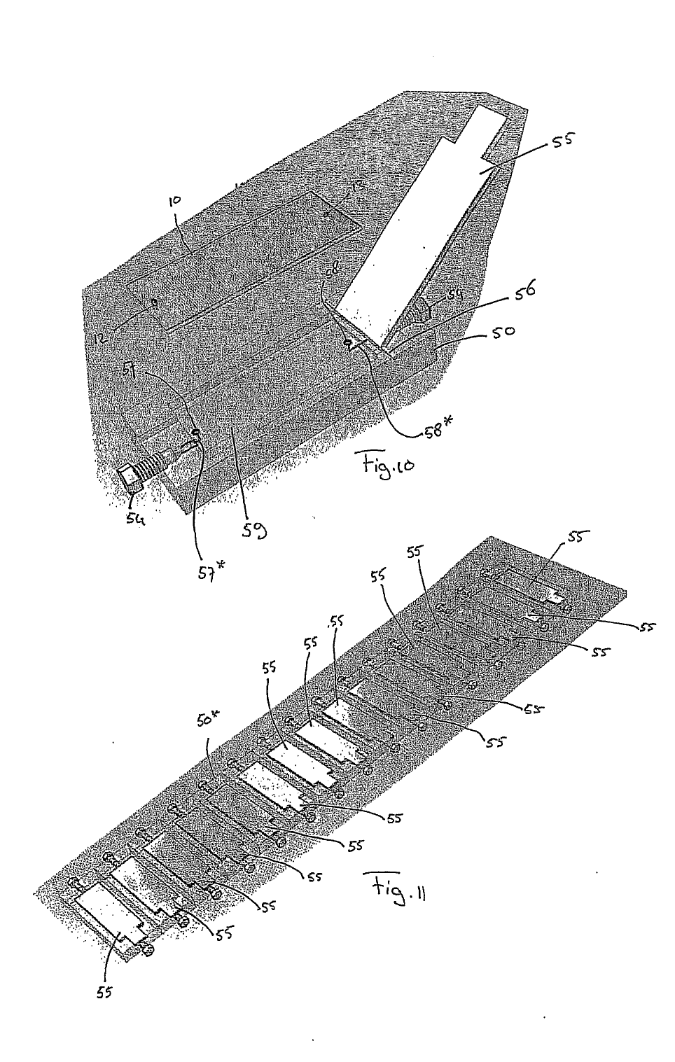

FIG. 10 shows a further possible embodiment of arranging a microfluidic chip 10 as used in the invention in a housing 50.

The housing 50 has a recess 59 for accommodating the microfluidic chip 10 as used in the invention. The housing comprises an inlet 57, that is arranged in such a way that it aligns with inlet 12 of the microfluidic chip. Likewise, the housing 50 comprises an outlet 58, that is arranged in such a way that it aligns with outlet 13 of the microfluidic chip. Preferably, a sealing element, for example an O-ring, is arranged around the inlet 57 as well as around the outlet 58 is such a way that the sealing elements are pressed tightly between the housing and the microfluidic chip when such a chip is arranged in the housing. A fluid supply line can be connected to the inlet 57 and a fluid discharge line can be connected to the outlet 58 via screws 54 and channels 57* and 58* respectively.

A lid 55 is provided to close off the recess when a microfluidic chip 10 is arranged inside the recess 59. Preferably, the lid 55 is hingedly connected to the housing 50 such that it can rotate about pin 56.

FIG. 11 shows a further embodiment of a housing for microfluidic chips that can be used in a flow controller assembly according to the invention. In this embodiment, a common housing 50* has been provided for accommodating a plurality of microfluidic chips. In the housing, a plurality of recesses 59 has been provided. Each recess is adapted to accommodate a single microfluidic chip, just like in the embodiment of FIG. 9. So, for each recess in the housing 50*, screws 54, an inlet 57, an outlet 58 and channels 57* and 58* are provided. Furthermore, each recess is provided with a lid 55, which lid 55 is hingedly connected to the housing 50*.

The embodiments of FIGS. 10 and 11 can be combined with all embodiments of the flow controller assembly that are described above.

1. A flow controller assembly for microfluidic applications, wherein the flow controller assembly comprises at least one microfluidic flow controller, wherein the microfluidic flow controller comprises:
a microfluidic chip, wherein the microfluidic chip comprises a channel for accommodating a fluid flow, wherein the channel runs through said microfluidic chip and has a channel inlet that is connectable to a fluid source and a channel outlet that is connectable to a further fluid conduits;
a thermal energy transmitter, wherein the thermal energy transmitter is adapted for heating and/or cooling at least a part of the channel by producing a thermal output, thereby influencing the flow rate of fluid that is present in said channels;
a flow sensor for measuring the flow rate of a fluid running through the flow controller, said flow sensor being adapted to produce flow rate measurement data;
a data control units;
wherein the data control unit is connected to the flow sensor by a first data connection
wherein the first data connection allows the data control unit to receive flow rate measurement data from the flow sensor;
wherein the data control unit is connected to the thermal energy transmitter by a second data connections;
wherein the second data connection allows the data control unit to influence the thermal output of the thermal energy transmitter; and
wherein the data control unit comprises a data processing unit that is adapted to determine the difference between the measured flow rate and a preset desired flow rate and to regulate the thermal output of the thermal energy transmitter in order to obtain or maintain the desired flow rate.

2. The Flow controller assembly according to claim 1, wherein the flow sensor is based on the time-of-flight principle.

3. The Flow controller assembly according to claim 2, wherein the flow sensor comprises:
a thermal pulse element that is arranged adjacent to the channel, which thermal pulse element is adapted to provide a thermal pulse in fluid running through said channel; and
a thermal pulse sensor;
wherein the thermal pulse sensor is arranged adjacent to the channel and at a preset distance downstream of the thermal pulse element for detecting the passing by of said thermal pulse;
wherein the flow controller further comprises a timer for determining the time that lapsed between the generation of the thermal pulse by the thermal pulse element and the detection of said thermal pulse by the thermal pulse sensor; and
wherein this determined time lapse is used in the determination of the flow rate.

4. The Flow controller assembly according to claim 1, wherein the microfluidic chip comprises a material selected from a group consisting of glass, quartz, silicon, or metal.

5. The Flow controller assembly according to claim 1, wherein the thermal energy transmitter comprises metal tracing that is deposited on the microfluidic chip.

6. The Flow controller assembly according to claim 1, wherein the thermal energy transmitter comprises a Peltier element.

7. The Flow controller assembly according to claim 1, wherein the first and/or second data connection comprises metal deposits on the microfluidic chip.

8. The Flow controller assembly according claim 1, wherein the flow controller assembly further comprises a housing for accommodating the microfluidic chip, wherein the housing is gas tight and/or thermally insulated.

9. The Flow controller assembly according to claim 8, wherein the housing comprises a indicator for indicating whether a microfluidic chip is present in said housing or not.

10. The Flow controller assembly according to claim 8, wherein the thermal energy transmitter comprises a circuit for a thermal fluid that allows thermal fluid to be circulated through it, such that a thermal fluid flowing through said circuit heats or cools at least a part of the microfluidic chip, and wherein the circuit is at least partly arranged inside the housing.

11. A system for performing a plurality of experiments in parallel, wherein the system comprises:
at least one source of fluid reagent;
a plurality of reactors; and
at least one flow controller assembly according to claim 1;
wherein the at least one microfluidic flow controller of the flow controller assembly is in fluid communication with said source of fluid reagent and with at least one of the plurality of reactors.

12. The system according to claim 11, wherein the system comprises a plurality of flow controller assemblies, or at least one flow controller assembly comprising a plurality of microfluidic flow controllers;
wherein each of the plurality of microfluidic flow controllers is in fluid communication with one of the plurality of reactors.

13. The system according to claim 11,
wherein the system comprises a plurality of flow controller assemblies, or at least one flow controller assembly comprising a plurality of microfluidic flow controllers;
wherein the channels of at least two microfluidic flow controllers have different diameters and/or lengths.

14. The system according to claim 11, wherein the preset desired flow rate is the same for all microfluidic flow controllers.

15. The system according to claim 11, wherein the system further comprises a system control unit; wherein the system control unit is connected to the data control units of the individual flow controllers.

16. A system for performing a plurality of experiments in parallel, wherein the system comprises:
at least one source of fluid reagent;
a plurality of microfluidic chips, wherein each microfluidic chip comprises a channel for accommodating a fluid flow, wherein the channel runs through said microfluidic chip and has a channel inlet and a channel outlet, and wherein the channel inlet is connected to said source of fluid reagent;
at least one thermal energy transmitter, wherein the thermal energy transmitter is adapted for heating and/or cooling at least a part of one or more of the channels by producing a thermal output, thereby influencing the flow rate of fluid that is present in said channels;
a plurality of flow sensors, wherein each flow sensor is associated with an individual channel, and wherein each flow sensor is adapted to produce flow rate measurement data relating to fluid flow in its associated channel;
a system data control unit;
wherein the system data control unit is connected to each flow sensor by a first data connection;
wherein the first data connection allows the data control unit to receive flow rate measurement data from each flow sensor;
wherein the data control unit is connected to the thermal energy transmitter by a second data connection;
wherein the second data connection allows the data control unit to influence the thermal output of the thermal energy transmitter,
wherein the system data control unit comprises a system data processing unit that is adapted to determine the difference between the measured flow rate in each channel and a preset desired flow rate for that channel and to regulate the thermal output of the thermal energy transmitter in order to obtain or maintain the desired flow rates; and
a plurality of reactors, each of the reactors being connected to a channel outlet via a further fluid conduit.

17. The system according to claim 16, wherein the system further comprises a housing for accommodating a plurality of microfluidic chips, wherein the housing is gas tight and/or thermally insulated.

18. The system according to claim 16, wherein a thermal energy transmitter is present that is adapted for heating and/or cooling at least a part of each of the channels.

19. The system according to claim 16,
wherein a plurality of heaters and/or coolers is present, each of the heaters and/or coolers being adapted for heating and/or cooling at least a part of a single associated channel.
